(19) United States
(12) Patent Application Publication
(10) Pub. No.: US 2024/0254336 A1
(43) Pub. Date: Aug. 1, 2024

(54) Plant Derived Composite Building Material

(71) Applicant: Justin Vetch, Shelby, MT (US)

(72) Inventor: Justin Vetch, Shelby, MT (US)

(21) Appl. No.: 18/103,062

(22) Filed: Jan. 30, 2023

(51) Int. Cl. C08L 97/02

(52) U.S. Cl. CPC C08L 97/02

(57) ABSTRACT

A kochia-derived composite building material made of particles of stems of kochia shrubs and a binder mixed with the particles. The stems of kochia shrubs are harvested and dried. The kochia stems are cut or ground into particles and mixed with a binder, thereby forming a semi-liquid mixture of particles and binder. The semi-liquid is dried, thereby forming a solid kochia-derived composite building material. The binder may be a formaldehyde-containing binder or a methylene diphenylisocyanate-containing binder. The semi-liquid may be placed in a mold to produce composite building material of a desired shape. The kochia composite building material will not burn, will float, is water resistant, and is durable.

### BACKGROUND OF THE DISCLOSURE

Kochia (Bassia scoparia) is an annual herbaceous shrub that has a deep taproot and grows 1.6 to 4.9 feet tall. Kochia stems are upright and spreading with many branches. Kochia is used by wildlife for food and cover. It can be hayed or grazed directly for livestock feed. Kochia can be planted for soil erosion control and bioremediation of some contaminated sites. It is used in some Asian cultures for food and in some parts of Europe and Asia it is planted for making brooms. Kochia is found on pasture, rangeland, roadsides, ditch banks, wastelands and cultivated fields.

Kochia is extremely hardy and well adapted to many environments across the world. It is often considered a weed in the US but has excellent nutritional value as a feed for livestock and is often fed to cattle, sheep, and goats. Kochia is also consumed regularly by people in Japan where the seeds are known as “land caviar”. The plant is extremely saline and drought tolerant making it an ideal crop for poor cropland. When the kochia dries later in its growth cycle it gains a hard, woody outer layer and a very stable, dense, spongy interior.

Wood composites include a range of different derivative wood products all of which are created by binding the strands, fibres or boards of wood together. Wood composite is also known as manmade wood, engineered wood, as well as wood-plastic composite (WPC). However, wood is expensive and manufacturing methods of wood composites are also expensive. The ability to make a composite with kochia is very desirable because of the low cost of obtaining kochia and the durability of its stems.

### SUMMARY OF THE DISCLOSURE

This disclosure provides method of making kochia-derived composite building material. Stems of kochia shrubs are harvested and dried. The dried kochia stems are cut or ground into particles. The particles are mixed with a binder, thereby forming a semi-liquid mixture of particles and binder. The binder may be any kind of binder, for example, a formaldehyde-containing binder or a methylene diphenylisocyanate-containing binder. The semi-liquid mixture may be placed in a mold to create a desired shape of building material. The semi-liquid mixture is dried, thereby forming a solid kochia-derived composite building material in a desired shape.

The particles are mixed with the binder, preferably, in a ratio of 3 parts particles to 1 part binder. The semi-liquid mixture may be compressed up to 6 tons of pressure for up to 5 minutes. The particles are, preferably, less than 2 mm in diameter.

The method of this disclosure provides a kochia-derived composite building material, comprising particles of stems of kochia shrubs and a binder mixed with the particles. The binder may be a formaldehyde-containing binder or a methylene diphenylisocyanate-containing binder. The particles are mixed with binder in a ratio of 3 parts particles to 1 part binder. The particles are, preferably, less that 2 mm in diameter.

An advantage of the method and composition of this disclosure is a composite building material made of the stems of the shrub kochia.

Another advantage is a composite building material that is inexpensive and easy to manufacture.

Another advantage is a composite building material that will not burn, will float, is water resistant, and is durable.

### BRIEF DESCRIPTION OF THE DRAWINGS

FIG. 1 shows a flow diagram of the method for producing the shrub derived composite building material of this disclosure.

FIG. 2 shows a flow diagram for making a board from ground kochia stem particles.

### DETAILED DESCRIPTION OF THE DISCLOSURE

While the following description details the preferred embodiments of the methods and processes of this disclosure, it is to be understood that the methods and processes are not limited in their application to the details of arrangement of the features or steps described in the disclosure, since the methods and processes are capable of other embodiments and of being practiced in various ways.

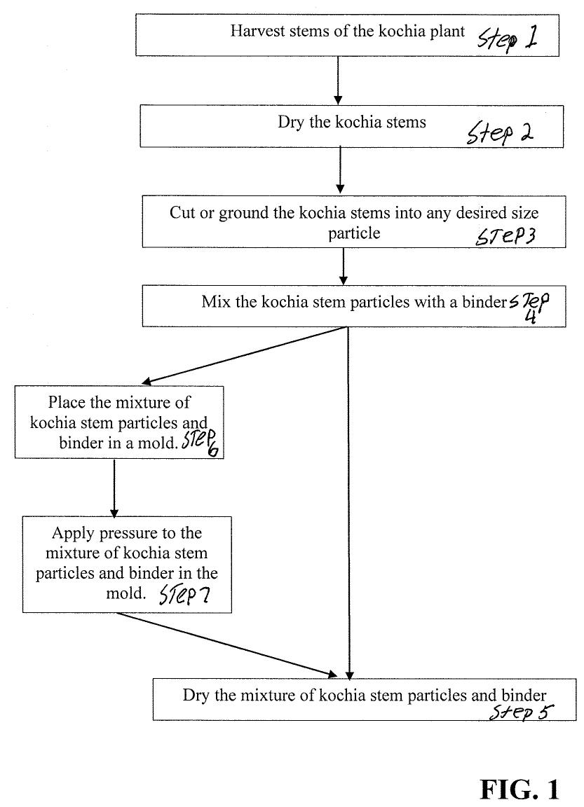

FIG. 1 shows a flow diagram of the general features for producing the shrub derived composite building material of this disclosure. This building material is a composite material made primarily from the stems of Bassio skoparia, also known as kochia. Kochia stems are erect, highly branched, round, and slender. The stems of the kochia plant are harvested (Step 1), dried (Step 2), and cut or ground into different particle sizes (Step 3), depending on the desired end-product. Although particles sizes up to 10 mm diameter will work, the preferred particle size is 0.1 to 3 mm in diameter. The ground kochia particles are then mixed with a binder or glue to form a semi-liquid mixture (Step 4). The mixture of kochia particles and binder is dried to form a solid building product (Step 5). Alternatively, the semi-liquid mixture of kochia stem particles may be placed into a mold of desire shape (Step 6). Pressure may then be applied to the semi-liquid mixture in the mold for a desired period of time (Step 7). The mixture is then allowed to dry (Step 5).

Many different binders are suitable for making this building material. Binders or glue include any type of formaldehyde-containing synthetic resins or any methylene diphenyl isocyanate containing binders.

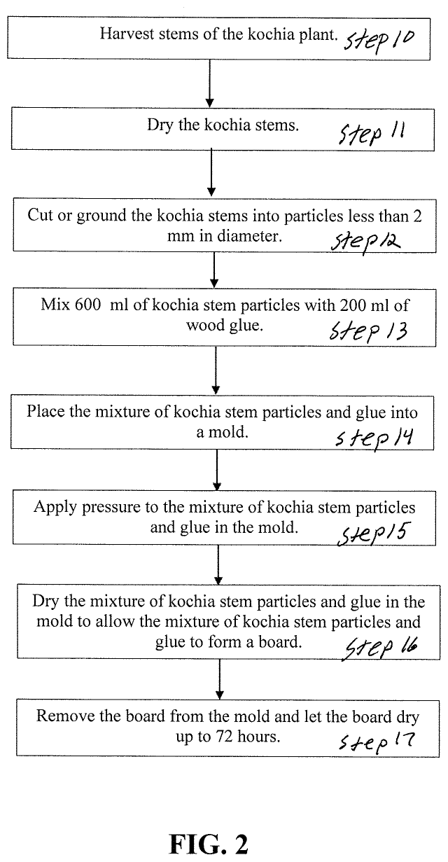

FIG. 2 shows a flow diagram for making an 8″×8″×½″ board from ground kochia stem particles. The stems of the kochia plant are harvested (Step 10), dried (Step 11), and cut or ground into particle sizes of less than 2 mm diameter (Step 12). 600 ml of ground kochia particles are then mixed thoroughly with 200 ml of Titebond II Premium Wood Glue™ to form a semi-liquid mixture (Step 13). Titebond II Premium Wood Glue™ is a formaldehyde-based glue. The semi-liquid mixture is placed into a 8″×8″×½″ mold (Step 14). Four to six tons of pressure are applied to the semi-liquid mixture in the mold for 2 to 5 minutes with a standard hydraulic press. The pressure is then released (Step 15). The semi-liquid mixture is allowed to dry in the mold up to 5 hours to form a board (Step 16). The board is removed from the mold and the board is allowed to continue drying up to 72 hours. (Step 17). This method produces a composite board of medium to light density that is 8″×8″×½″ in dimension. The board will not burn, will float, is water resistant, and is durable. The kochia derived composite building material of this disclosure is particularly useful for building cabinets, desks, and dressers, and for providing insulation of sound and heat.

The foregoing description illustrates and describes the disclosure. Additionally, the disclosure shows and describes only the preferred embodiments but as mentioned above, it is to be understood that the preferred embodiments are capable of being formed in various other combinations, modifications, and environments and are capable of changes or modifications within the scope of the invention concepts as expressed herein, commensurate with the above teachings and/or the skill or knowledge of the relevant art. The embodiments described herein above are further intended to explain the best modes known by applicant and to enable others skilled in the art to utilize the disclosure in such, or other, embodiments and with the various modifications required by the particular applications or uses thereof. Accordingly, the description is not intended to limit the disclosure to the form disclosed herein. Also, it is intended that the appended claims be construed to include alternative embodiments.

What is claimed is:

1. A method of making kochia-derived composite building material, comprising:
1) providing stems of kochia shrubs;
2) drying the kochia stems;
3) cutting or grinding the kochia stems into particles;
4) mixing a binder with the particles, thereby forming a semi-liquid mixture of particles and binder;
and
5) drying the semi-liquid mixture, thereby forming a solid kochia-derived composite building material.

2. The method of claim 1, wherein the binder is a formaldehyde-containing binder or a methylene diphenylisocyanate-containing binder.

3. The method of claim 1, further comprising placing the semi-liquid mixture in a mold before drying.

4. The method of claim 1, further comprising mixing the particles with the binder in a ratio of 3 parts particles to 1 part binder.

5. The method of claim 1, further comprising compressing the semi-liquid mixture up to 6 tons of pressure for up to 5 minutes.

6. The method of claim 1, wherein the particles are less that 2 mm in diameter.

7. A method of making kochia-derived composite building material, comprising:
1) providing stems of kochia shrubs;
2) drying the kochia stems;
3) cutting or grinding the kochia stems into particles;
4) mixing a binder with the particles, thereby forming a semi-liquid mixture of particles and binder, wherein the binder is a formaldehyde-containing binder or a methylene diphenylisocyanate-containing binder;
5) placing the semi-liquid mixture in a mold; and
6) drying the semi-liquid mixture, thereby forming a solid kochia-derived composite building material.

8. The method of claim 7, further comprising mixing the particles with the binder in a ratio of 3 parts particles to 1 part binder.

9. The method of claim 7, further comprising compressing the semi-liquid mixture up to 6 tons of pressure for up to 5 minutes.

10. The method of claim 7, wherein the particles are less that 2 mm in diameter.

11. A kochia-derived composite building material, comprising:
1) particles of stems of kochia shrubs; and
2) a binder mixed with the particles.

12. The kochia-derived composite building material of claim 11, wherein the binder is a formaldehyde-containing binder or a methylene diphenylisocyanate-containing binder.

13. The kochia-derived composite building material of claim 11, wherein the particles are mixed with binder in a ratio of 3 parts particles to 1 part binder.

14. The kochia-derived composite building material of claim 11, wherein the particles are less than 2 mm in diameter.
